(19) United States
(12) Patent Application Publication
(10) Pub. No.: US 2012/0190831 A1
(43) Pub. Date: Jul. 26, 2012

(54) Methods for Steam Flash Extraction of Pectin

(75) Inventors: Brian Rudolph, Lellinge (DK); Sune Allan Petersen, Greve (DK)

(73) Assignee: CP KELCO APS, Lille Skensved (DK)

(21) Appl. No.: 13/013,709

(22) Filed: Jan. 25, 2011

(51) Int. Cl. C08B 37/06

(52) U.S. Cl. 536/2

(57) ABSTRACT

Methods are provided for high temperature and short time extraction of pectins from pectin-containing plant materials. Generally described, the method includes mixing the pectin-containing plant material and an acidic aqueous medium to form a mixture; heating the mixture (optionally under pressure) to a target temperature by steam injection; maintaining the mixture under pressure at the target temperature for a time up to about 5 minutes; and flashing the mixture into a flash tank at a pressure from about 0.5 to about 1.2 bar to extract pectin from the pectin-containing plant material.

### TECHNICAL FIELD

Embodiments of the present description relate to methods for steam flash extraction of high quality pectins. In particular, the present description relates to high-temperature and short-time extraction processes of pectin from citrus peels that avoid significant degradation of pectin during the extraction process.

### BACKGROUND

Pectin is a complex polysaccharide associated with plant cell walls. It consists of an alpha 1-4 linked polygalacturonic acid backbone intervened by rhamnose residues and modified with neutral sugar side chains and non-sugar components such as acetyl, methyl, and ferulic acid groups. The neutral sugar side chains, which include arabinan and arabinogalactans, are attached to the rhamnose residues in the backbone.

A significant amount of research on pectins has been carried out due to its importance as a food product, a dietary fiber and a component of cell walls in higher plants, and to the growing awareness of a number of pharmacological activities. Current methods of extracting pectin, however, do not produce pectins of sufficient quality for all such uses. Accordingly, millions of pounds of pectin extracted from raw materials are unsuitable for use in food products.

Conventional methods of pectin extraction require extended heating of the pectin-containing plant materials at sub-boiling temperatures (approximately 65-85° C.) in an acidic media for 2 to 10 hours. These processes, however, have high residence times and energy requirements and may provide only a moderate yield (20-30%) of pectin having an acceptable quality. Although it is known that increased extraction temperatures require a shorter extraction time for a comparable yield, pectin is sensitive to high temperatures and will degrade when exposed to high temperatures (as evidenced by decreases in molecular weight and intrinsic viscosity).

Thus, there remains a need to develop an efficient and effective method for extracting pectin from pectin-containing plant materials without degrading the pectin quality too much.

### SUMMARY

The present application addresses the above-described needs by providing a process for extracting pectin from pectin-containing plant material comprising: mixing the pectin-containing plant material and an acidic aqueous medium to form a mixture; heating the mixture (optionally under pressure) to a target temperature by steam injection, wherein the target temperature is from about 100° C. to about 120° C.; maintaining the mixture under pressure at the target temperature for a time up to about 5 minutes; and flashing the mixture into a flash tank at a pressure from about 0.5 to about 1.2 bar to extract pectin from the pectin-containing plant material.

In other embodiments, pectins obtained by a process for extracting pectin are provided.

Additional aspects will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1 is a schematic illustration of a system for extracting pectin according to a particular embodiment.

### DESCRIPTION

Embodiments of the present invention relate to methods for steam flash extraction of high quality pectins from pectin containing materials. Generally described, the method comprises mixing the pectin-containing plant material and an acidic aqueous medium to form a mixture; heating the mixture (optionally under pressure) to a target temperature of at least about 100° C. by steam injection; maintaining the mixture under pressure at the target temperature for a time up to about 5 minutes; and flashing the mixture into a flash tank at a pressure from about 0.5 to about 1.2 bar to extract pectin from the pectin-containing plant material.

Not wishing to be bound by any theory, it is believed that the flashing of the pectin results in an explosive discharge of the pressurized extraction mixture. The residual moisture in the pectin-containing plant material undergoes a similar expansion, promoting disintegration of the material and increasing the extraction-surface of the pectin-containing plant material available. Simultaneously, the pressure drop instantly cools the mixture, thereby minimizing degradation of the pectin.

Pectin-containing plant materials are well-known in the art and include fresh and processed materials as well as plant residues. Desirably, the pectin-containing plant material is a fruit, non-limiting examples of which include stone fruits such as peaches, pome fruits such as apples, and citrus fruits such as limes, lemons, oranges and grapefruit. The material may be prepared for extraction using any suitable means and any suitable portion of the pectin-containing plant material, for example, by juicing, peeling, coarsely chopping, milling or grinding the pectin-containing plant material or portions thereof. In particular embodiments, the pectin-containing plant material is the fruit peel. The fruit peel of a citrus fruit, as used herein, means the flavedo, albedo, and juice sacks (pulp sacks) which remain after juicing the fruit. In alternative embodiments, the pectin-containing plant material is one or more portions of the fruit peel (e.g., the albedo, fractions of albedo, juice sacks, or combinations thereof).

The pectin-containing plant material is mixed with an aqueous acidic medium to form an extraction mixture. The acidic aqueous medium may have a pH ranging from about 1 to about 5, from about 1 to about 3, or from about 2 to about 3. Acidic aqueous media which are useful include, but are not limited to, minerals acids such as hydrochloric acid, sulfuric acid, or nitric acid, or organic acids such as acetic acid, oxalic acid, or citric acid, and mixtures thereof. Desirably, the pectin-containing plant material and acidic aqueous medium are present in the mixture at a ratio from about 1:2 to about 1:40 (w/w), depending on the peel-type and physical state. In exemplary embodiments, the pectin-containing plant material and acidic aqueous medium are present in the mixture at a ratio from about 1:2 to about 1:10 (w/w), from about 1:2 to about 1:4 (w/w), or more particularly about 1:3 (w/w).

The mixture of pectin-containing plant material and acidic aqueous medium is then sealed in an extraction vessel and heated (optionally under pressure) to a target temperature by injecting steam into the extraction vessel. In particular embodiments, the steam injected into the extraction vessel is at a temperature and a pressure sufficient to heat the mixture in the extraction vessel to a target temperature from about 100 to about 120° C., from about 105 to about 115° C., or from about 110 to about 115° C. In embodiments, the pressure in the extraction vessel is maintained at about atmospheric pressure or greater (e.g., at about atmospheric pressure, at a pressure at least about 0.2 bar greater than the pressure of the flash tank, or at least about 0.4 bar greater than the pressure of the flash tank). Those skilled in the art, however, will appreciate that the temperature, pressure, and flow of steam into the extraction vessel may be modified according to the type of materials, the amount of materials in the mixture, the target temperature and pressure of the extraction vessel, and the equipment being used, and that the optimum conditions for steam injection may be arrived at experimentally.

After reaching the target temperature, the mixture is maintained at the target temperature to allow for extraction of the pectin for a time up to about 5 minutes. The mixture is subsequently flashed into a flash tank at a pressure from about 0.5 to about 1.2 bar, from about 0.8 to about 1.1 bar, or at about atmospheric pressure (e.g., 1.013 bar). The time required for optimum extraction, which is measured from the time the mixture reaches the target temperature, may vary according to the material utilized and may be arrived at experimentally. In exemplary embodiments, the mixture is maintained at the target temperature for a time up to about 4 minutes, up to about 3 minutes, up to about 2.5 minutes, up to about 2 minutes, up to about 1.5 minutes, up to about 1 minute, or up to about 30 seconds. In still another exemplary embodiment, the mixture is immediately flashed upon reaching the target temperature and the time for extraction is effectively about 0 minutes.

The flash tank for the steam flash discharge of the extraction mixture from the high pressure extraction chamber desirably has a vent allowing for the unrestricted expansion during the steam explosion. In particular embodiments, an aqueous medium (e.g., distilled water) at about room temperature (e.g., at about 25° C.) may be disposed in the flash tank prior to flashing of the extraction mixture, such that the hot extraction mixture is flashed directly into the aqueous medium, thereby instantly cooling (and diluting) the extraction mixture to non-critical extraction temperatures (i.e., to temperatures below the degradation temperature of the pectin). However, those skilled in the art will appreciate that the temperature of the flash tank also may be cooled below room temperature in embodiments in which the flash tank is below atmospheric pressure.

In particular embodiments, the mixture may be cooled further using methods known to those skilled in the art. The mixture then may be filtered or separated using other suitable means to obtain the aqueous acidic medium containing the extracted pectin from the residue of the pectin-containing material. The extracted pectin then may be precipitated from the aqueous acidic medium, for example, with addition of an effective amount of alcohol. Useful alcohols include, but are not limited to, any alcohol which is compatible with food applications and which effectively precipitates pectins and dissolves alcohol-soluble materials. In particular embodiments, the alcohols are isopropyl alcohol or ethanol. Following precipitation, the extracted pectin may be separated and washed with alcohol to remove as many alcohol-soluble impurities as possible. The pectin then may be dried and processed into a powder or further modified (e.g., de-esterified and/or amidated) using methods known in the art.

The extraction processes described herein provide a high quality pectin in a significantly shorter time than conventional extraction methods, and at comparable yields to conventional extraction methods, despite use of temperatures that are known to result in degradation of pectin quality. The quality of the pectin may be characterized, for example, by its intrinsic viscosity and molecular weight using methods known to those skilled in the art. In embodiments, the extracted pectin may be characterized as having a high intrinsic viscosity (e.g., from about 3.0 to about 8.0 dL/g, from about 4.0 to about 6.5 dL/g, or from about 5.0 to about 6.5 dL/g, as measured by size exclusion chromatography). In embodiments, the extracted pectin also may be characterized by its purity (based on the amount of galacturonic acid), clarity, ° SAG, or calcium sensitivity.

Embodiments of the present description are further illustrated by the following examples, which are not to be construed in any way as imparting limitations upon the scope thereof. On the contrary, it is to be clearly understood that resort may be had to various other embodiments, modifications, and equivalents thereof which, after reading the description therein, may suggest themselves to those skilled in the art without departing from the spirit of the present invention and/or the scope of the appended claims. Unless otherwise specified, quantities referred to by percentages (%) are by weight (wt %).

### EXAMPLES

### Example 1

A series of preliminary experiments were conducted using particular combinations of different parameters, as summarized in the table below, to demonstrate the ability to extract pectin by a steam flash injection process.

| | | Ex- | | | |
|---|---|---|---|---|---|
| Sample | Peel | traction | Peel:Extraction | Extraction | Extraction |
| No. | Type⁺ | Media* | Media\hat{ } | Temperature^{⋄} | Time |
| 1-1 | Dried | Water | 0.25:2.75 | 130 | 5 |
| 1-2 | Fresh | Water | 1:2 | 130 | 5 |
| 1-3 | Fresh | Acid | 1:2 | 130 | 5 |
| 1-4 | Fresh | Acid | 2:1 | 130 | 5 |
| 2-1 | Fresh | Acid | 1:2 | 125 → 123 | 2 |
| 2-2 | Fresh | Acid | 1:2 | 130 → 123 | 5 |
| 2-3 | Fresh | Acid | 1:2 | 116 → 114 | 2 |
| 2-4 | Fresh | Acid | 1:2 | 110 | 2 |
| 2-5 | Fresh | Acid | 1:2 | 115 | 2 |
| 2-6 | Alcohol | Acid | 1:2 | 132 | 2 |

⁺Dried = dried peel; Fresh = fresh orange peel; Alcohol = isopropyl alcohol washed and drained orange peel
*Water = Deionized Water; Acid = 0.62 wt % nitric acid
\hat{ }Kg peel material to liters of extraction media
^{⋄}Arrows denote that extraction temperatures decreased during the extraction period

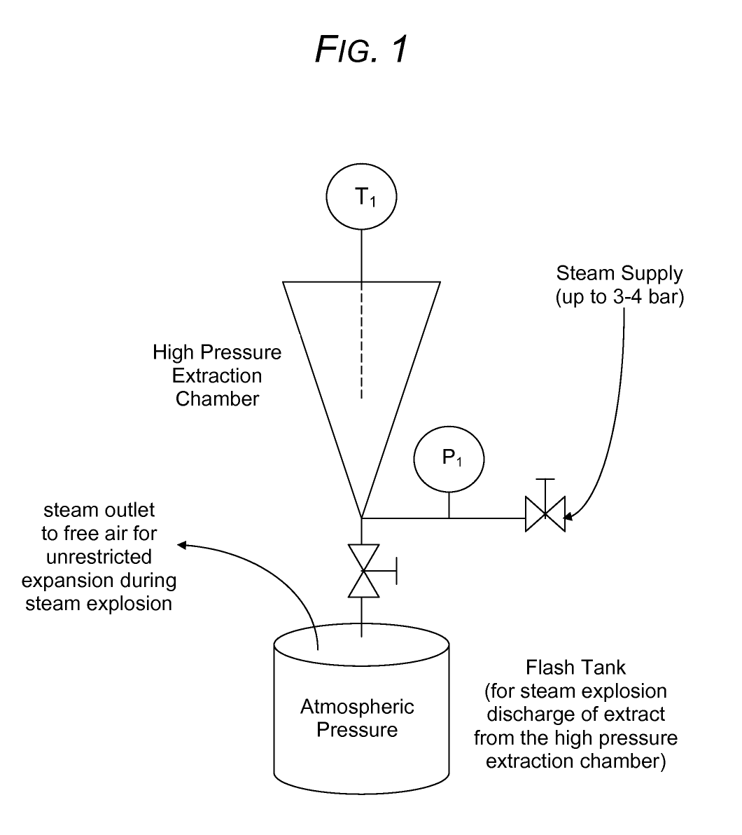

The samples were prepared shortly (i.e. few minutes) before being heated to the target extraction temperature for the specified time. Immediately following the extraction time, the extraction mixture was explosively discharged into the flash tank by manually opening the valve connected to the high pressure extraction chamber (FIG. 1). Samples were collected shortly after the flash process (i.e. within a few minutes).

For all group 2 samples (except sample 2-3), the total quantity of flash-extract was weighed in order to quantify the steam consumption of the process. Sample 2-3 was not weighed in due to a spill through the bottom valve of the flash tank. The extracts were centrifuged for 10 min at 5000 rpm using a Sorval RCSB centrifuge with the large rotor. Because the supernatants were still cloudy after centrifugation and seed remained on the top of the supernatants, the supernatants were subsequently filtered using a Büchner funnel and cellulose filter aid (Filtered 450).

Pectin was precipitated by pouring filtered juice into at least 3 volumes of IPA while stirring using a “fish tale”. The precipitated pectin was collected and drained manually using a filter cloth. The drained pectin was plucked and then dried in a drying chamber at temperatures varying from 60-65° C. overnight. The dried pectin was subsequently milled and the intrinsic viscosity analyzed.

| | | Actual | | Normalized | |
|---|---|---|---|---|---|
| | Steam | Pectin | Overall | Overall | |
| Sample | Consumption | Yield | Pectin Yield | Pectin Yield | IV |
| No. | (kg) | (g) | (g) | (g) | (dL/g) |
| 1-1 | | 3.8 | | | 3.2 |
| 1-2 | | 1.9 | | | 1.7 |
| 1-3 | | 2.49 | | | 1.1 |
| 1-4 | | 3.57 | | | 2.1 |
| 2-1 | 4 | 2.14 | 23.6 | | 2.9 |
| 2-2 | 3.5 | 2.38 | 25.7 | | 1.8 |
| 2-3 | — | 3.38 | — | | 3.6 |
| 2-4 | 1.5 | 2.77 | 21.9 | | 4.1 |
| 2-5 | 2.5 | 4.24 | 36.2 | 25.3 | 4.5 |
| 2-6 | 7.8 | 2.97 | 54.5 | 38.2 | 2.4 |

The table above lists the results of each extraction. As shown above, the steam consumption was detected for all samples (except Sample 2-3) prepared on day 2 of the experiment. The mass of precipitated pectin material and amount of filtered pectin supernatant obtained from a given mass of pectin extract were used to calculate the pectin concentration in the filtered supernatant of the pectin extract. The overall pectin yield in grams per sample was then calculated by dividing the total extraction mass with the amount used for pectin precipitation followed by multiplying with the pectin mass which was isolated from the mass of extract used for pectin purification. The overall pectin yields were then normalized for samples of alcohol washed peel corresponding to the fruit quantity used for fresh peel extractions. Finally, the intrinsic viscosity of all samples was determined using the FIPA for supernatant analysis.

The intrinsic viscosity ranged between 1.1 to 4.6 dL/g and was dependent on the type of raw material, acidity of the extraction media, extraction temperature and time of extraction. Not wishing to be bound by any theory, it is believed that the intrinsic viscosities were lower than anticipated because of the higher extraction temperatures (i.e., >about 115° C.), which are known to cause a significant reduction in IV. Moreover, these experiments demonstrate that steam-flash extraction of pectin is non-trivial and is highly dependent on the various parameters, particularly temperature and time.

### Example 2

Freshly produced alcohol washed orange peel was used as a raw material. For each extraction, 700 g of peel was mixed with 2300 g of extraction media a few minutes before extraction. Either 0.63% nitric acid or 0.15% oxalic acid (1.5 g oxalic acid and 0.145 g sodium hydroxide per liter) were used as the extraction media. Extractions were carried out by increasing the temperature of the extraction mixture as fast at possible to reach 110° C., while taking care not to exceed the temperature by more than 3° C. The extractions were then maintained at the target temperature for 0, 2, or 4 minutes before being flashed into an extraction tank at atmospheric pressure. Accordingly, the 0 ruin extraction corresponded to immediately flashing the heated mixtures after reaching the target temperature. After certain extractions, post-extraction cooling was achieved by adding approximately distilled water (3 L, 25° C.) at the bottom of the Flash tank prior to extraction (denoted by +in the table below). Consequently, the 110° C. hot extraction mixture was flashed directly into the distilled water, providing instant cooling and dilution of the extraction mixture, thereby reducing the viscosity of the extraction mixture to facilitate the subsequent filtration step. The conditions and results of each extraction and its subsequent processing are listed in the tables below.

| | | Time to | | |
|---|---|---|---|---|
| Sample | | Heat to 110° C. | Extraction Time | Cooling |
| No. | Extraction Media | (min:sec) | (min) | (+/−) |
| N1 | Nitric Acid | 1:54 | 0 | + |
| N2 | Nitric Acid | 2:28 | 4 | + |
| N3 | Oxalic Acid | 1:37 | 0 | + |
| N4 | Oxalic Acid | 1:40 | 4 | + |
| N5 | Nitric Acid | 2:03 | 0 | − |
| N6 | Nitric Acid | 1:54 | 4 | − |
| N7 | Oxalic Acid | 1:57 | 0 | − |
| N8 | Oxalic Acid | 1:53 | 4 | − |
| N9 | Nitric Acid | 1:51 | 2 | + |
| N10 | Nitric Acid | 2:16 | 2 | + |
| N11 | Nitric Acid | 1:40 | 2 | + |
| N12 | Nitric Acid | — | 2 | − |
| N13 | Nitric Acid (½) | 2:14 | 2 | − |
| N14 | Nitric Acid (⅓) | 1:32 | 2 | − |

| | | Steam | | |
|---|---|---|---|---|
| | | Consumption/SF | Overall | |
| | Steam | pectin mass | Pectin | |
| | Consumption | produced | Yield | IV |
| Sample No. | (kg) | (kg/kg) | (wt %) | (dL/g) |
| N1 | 1.0 | 31 | 22.8 | 5.0 |
| N2 | 1.3 | 48 | 19.4 | 3.2 |
| N3 | 1.6 | 82 | 13.8 | 5.5 |
| N4 | 1.7 | 65 | 18.1 | 4.9 |
| N5 | 1.3 | — | — | 3.8 |
| N6 | 2.8 | 84 | 23.8 | 4.2 |
| N7 | 1.3 | 89 | 9.99 | 6.5 |
| N8 | 1.2 | 50 | 17.3 | 3.8 |
| N9 | 0.8 | 20 | 28.8 | 4.8 |
| N10 | 1.3 | 34 | 27.2 | 3.1 |
| N11 | 1.2 | 31 | 27.2 | 3.0 |
| N12 | 0.8 | 30 | 18.8 | 3.8 |
| N13 | 0.7 | 58 | 8.66 | 4.0 |
| N14 | 0.8 | 42 | 13.7 | 3.9 |

### Appearance of Steam Flash Extracts:

Photos (not shown here) were taken of the steam flash extracts prior to downstream processing (i.e., filtering and pectin precipitation). Clear differences in texture were observed between the extractions yielding highest (6.5) and the lowest (3.0) intrinsic viscosities, which can be attributed to both the amount and sizes of particle residuals as well as the viscosity. The highest IV extract (N7) appeared to be much more viscous (having an approximate consistency of stewed apples with larger particles remaining) as compared to the lower IV extract (N11) (having a consistency more like mashed apples diluted with water). Though not quite as distinct, a similar difference in texture was observed between samples N1 (IV=5.0) and N10 (IV=3.1) as well.

### Appearance of Precipitated and Dried Pectin (Before Milling):

Photos also were taken of precipitated and dried pectin produced from steam flash extracts. Clear differences also were observed in the structure of the dried pectin precipitate between the extractions yielding the highest (N7) and lowest (N11) intrinsic viscosities. The high viscosity extract of sample N7 yielded a slightly cotton wool like and filamentous pectin structure while lowest viscosity extract of sample N11 yielded a pectin with a more dense and not thread like structure.

### Heat Consumption in the Steam Flash Extraction Process:

Steam consumption has been recorded for each of samples N1 to N14 in attempt to provide a rough estimate about the heat required for steam flash extraction compared to the existing extraction procedures used for HM-pectin manufacturing. The steam consumptions were calculated as the difference in masses of peel/acid slurries before and after extraction, neglecting the loss of steam used to evacuate the extraction chamber for air during the phase of heating up extraction slurries. Results show steam consumptions varied from 0.7-2.8 kg used to extract pectin from 700 g alcohol washed orange peel. Based on the resulting pectin yields, the quantity of steam (kg) at 3 bar consumed per kg semi-finished pectin produced was calculated and. Values varied significantly from 19.8-89.4 kg steam per kg semi-finished pectin. These varying numbers are based on using the steam flash equipment as is. Not wishing to be bound by any theory, it is believed that the considerable variation resulted from the lack of thermal insulation of the process equipment.

### Filtration of Steam Flash Extracts:

Steam flash extracts were filtered using cellulose based filter aid and Büchner funnel. Initially, two filtrations (N10 and N2) were conducted without diluting the extract with deionised water, resulting in clogging of the filter before all pectin juice was separated from the remaining peel particles. Accordingly, remaining filtrations were conducted using about 1:1 (w/w) extract-to-water slurries. The amount of extract and water used to produce these slurries and the amount of filtrate produced from these slurries were used to calculate the filtration efficiency (%). There was no clear dependence on whether samples were diluted or not during the flash/cooling process.

Pectin was precipitated from filtered pectin juice/extract using at least three volumes isopropanol (IPA), drained, and dried at 60-65° C. overnight. From the quantities of dried pectin and filtrate volumes, the pectin concentration in the filtered juice was calculated. The pectin concentrations varied from 2.5-6.9 wt % in the juice, with no clear link to the filtration efficiencies.

Overall pectin yields were calculated by assuming that 0.7 kg alcohol washed peel ˜1.4 kg fresh peel ˜0.14 kg dried peel. The results generally showed quite promising yields, with a large fraction close to or above 20 wt %, which is considered to be a threshold value from an economical aspect (see horizontal dotted line in FIG. 2). Regarding pectin quality as characterized by IV, best results were obtained using oxalic acid for extraction (N7 and N3), however, significantly lower pectin yields were also obtained (10 and 14 wt %, respectively).

Factors affecting pectin yields were assessed using the Modeling and Experimental designing software MODDE version 9.0. Results suggest that extraction time, apparently, had no effect on pectin yields, whereas nitric acid (HNO₃) and oxalic acid, respectively, show clear positive and negative effects. These effects may—if not entirely, then at least partly—be explained by differences in extraction pH because samples extracted with nitric acid generally showed lower pH (˜2) after extraction compared to samples extracted with oxalic acid (˜ph 3.8), and knowing that lower pH, theoretically, more efficiently degrades protopectin to produce higher quantities of extractable pectin.

Intrinsic viscosity (IV) is a measure of to what degree a certain pectin sample contributes to the viscosity (η) of a solution at standardized conditions. Thus, IV is a pectin quality parameter, which tells something about the functionality of a pectin sample. Varying intrinsic viscosities (IVs) were obtained using the different extraction parameters. The best qualities were obtained from samples N7 and N3, which were both produced using oxalic acid and 0 min extraction time at 110° C. Relatively high IVs (5.0 and 4.8 dL/g for samples N1 and N9, respectively) were also obtained by using nitric acid as extraction media, as long as the extraction time was kept relatively short (in this case 0 and 2 min, respectively).

In addition, MODDE 9.0 also was used to analyze factors affecting IV, and results suggest there was a slightly negative effect of extraction time (i.e. longer extraction time→lower IV). This is consistent with the knowledge of those skilled in the art, based on knowledge of pectin's chemical instability at high temperatures (i.e. above about 80° C.). MODDE results also showed negative and positive effects on IV by using nitric acid (HNO3) and oxalic acid, respectively—despite a few of the samples showing a quite good IV by extraction with nitric acid. Based on the foregoing, extraction medias containing oxalic acid or mixtures of oxalic acid and nitric acid may provide desirable results.

Results also show a possible connection between the texture/appearance of a pectin extract, the structure/appearance of the corresponding precipitated pectin, and the quality of the derived semi-finished pectin measured as the IV. For sample N7, which was produced using oxalic acid and 0 min extraction at 110° C., a quite viscous steam flash extract was obtained, which upon dilution, filtration and precipitation, produced pectin with a slightly cotton wool like and filamentous structure. This filamentous pectin was subsequently analysed by Viscotek, showing a relatively high IV of 6.5. Unfortunately, the pectin yield was also quite low (about 10 wt %) for said sample compared to sample N11 (27.2 wt %), which oppositely showed relatively low IV (3.0). Interestingly, sample N11 was produced from a less viscous extraction mixture, which was prepared using nitric acid and 2 min extraction at 110° C. From this extraction mixture pectin of denser structure was prepared, indicating a slightly negative effect by using nitric acid (i.e., a low pH) and extended extraction times.

Data treatment in MODDE 9.0 showed effects of acid type (i.e. nitric or oxalic), however this may just as well be related to extraction pH, since we are dealing with strong and relatively weak acids, respectively. Moreover MODDE results indicated a negative effect of extraction times, which supports current knowledge stating that pectin is rapidly degraded at high temperatures (>80° C.). No IV-effect of instant cooling after flashing was shown here, and nor have the nitric acid concentration.

### Example 3

Additional experiments were conducted to further evaluate the pectin quality and practical yields of steam flash extraction. A fresh unwashed/chopped orange peel was used as raw material, and was juiced/chopped no earlier than the day before use. The juiced/chopped peels were kept cooled (˜0-8° C.) to inhibit pectin degrading enzymatic activity.

For each experiment, approximately 750 g of chopped peel was pre-mixed with 2250 g extraction media (i.e. diluted nitric acid, ˜62 wt %). Pre-mixing was conducted shortly (few minutes) before the extraction. The peel/acid/water slurry was then pre-heated to 110° C.±3° C. in the shortest possible time and extraction was conducted by holding the slurry for a period of 0 or 2 min. at 110° C.±3° C. Immediately after completed extraction, the slurry was flashed/discharged directly into a flash tank.

Samples were collected in buckets from 10 consecutive extractions, sealed after the last (i.e. 10^{th}) extraction, and stored at ambient temperature until for subsequent purification of the pectin on the same day. The samples were subsequently heated gently to a temperature of about 70° C. followed by filtering on Büchner funnel, which was pre-coated with 500 g filter aid (Filtercel 450). Filtration was completed after no more than one hour, irrespective of whether the extraction-mixture had been completely filtered or not.

The juice-filtrate was quantified (kg) before ion-exchange. The ion-exchanged pectin juice was precipitated using three volume parts 80% IPA. Remaining part of the SF-pectin preparation is as described in same procedure.

| | | Time of | | | | Amount |
|---|---|---|---|---|---|---|
| | | pre- | Extraction | Time of | pH after | of |
| Sample | Boil | heating | temperature | extraction | extraction | extract |
| name | No | (mm:ss) | (° C.) | (mm:ss) | (A.U.) | (kg) |
| A-0 min | 1 | 01:15 | 110 | 00:00 | 1.8 | 38.34 |
| | 2 | 00:59 | 110 | 00:00 | | |
| | 3 | 01:18 | 110 | 00:00 | | |
| | 4 | 02:56 | 110 | 00:00 | | |
| | 5 | 01:22 | 110 | 00:00 | | |
| | 6 | 02:12 | 110 | 00:00 | | |
| | 7 | 01:27 | 110 | 00:00 | | |
| | 8 | 00:57 | 110 | 00:00 | | |
| | 9 | 01:47 | 110 | 00:00 | | |
| | 10 | 01:13 | 110 | 00:00 | | |
| A-2 min | 1 | 02:18 | 110-111 | 02:00 | 2.1 | 38.54 |
| | 2 | 02:30 | 110-112 | 02:00 | | |
| | 3 | 02:00 | 110-113 | 02:00 | | |
| | 4 | 01:22 | 110-114 | 02:00 | | |
| | 5 | 03:01 | 110-111 | 02:00 | | |
| | 6 | 01:25 | 110-111 | 02:00 | | |
| | 7 | 02:04 | 110-109 | 02:00 | | |
| | 8 | 01:28 | 110-109 | 02:00 | | |
| | 9 | 02:38 | 110-109 | 02:00 | | |
| | 10 | 02:08 | 110-109 | 02:00 | | |

| | | | | | | | | Characterisation of SF pectin samples | | | | |
|---|---|---|---|---|---|---|---|---|---|---|---|---|
| | Permeate | | Turbidity | | SF Pectin | | | | Galacturonic | | | |
| | used for | pH in | in | Viscosity | from | | Yield, | | Acid | | Calcium | IV v. |
| Sample | precipitation** | Permeate | permeate | at 50° C. | extract | Conc.* | practical | DE | content | SAG | sensitivity | SEC |
| No. | kg | A.U. | NTU | mPa*s | (g) | g/kg | wt % | mol % | wt % | ° SAG | mPa*s | dL/g |
| A-5-0 min | 10.5 | 2.06 | 186 | 11.5 | 74.9 | 7.1 | 32 | 69.5 | 83.4 | 219 | 19.5 | 5.5 |
| A-5-2 min | 12.8 | 2.37 | 298 | 10.6 | 80.2 | 6.3 | 27 | 71.4 | 82.9 | 215 | 20 | 5.6 |

| | | | | | | |
|---|---|---|---|---|---|---|
| Reference values for orange peel extracted at standard conditions | 29 | 69.3 | 80 | 200 | 20 | 5.2 |

As the foregoing data illustrates, pectin extracted by steam flash extraction in scaled-up experiments was of sufficiently high quality and yield to be of commercial interest. Specifically, the steam flash extracted pectin was characterized by its IV, SAG, calcium sensitivity, and DE as comparable to or better than that of pectin extracted using conventional methods.

While the invention has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereof.

What is claimed is:

1. A process for extracting pectin from pectin-containing plant material comprising:
mixing the pectin-containing plant material and an acidic aqueous medium to form a mixture;
heating the mixture (optionally under pressure) to a target temperature by steam injection, wherein the target temperature is from about 100° C. to about 120° C.;
maintaining the mixture under pressure at the target temperature for a time up to about 5 minutes; and
flashing the mixture into a flash tank at a pressure from about 0.5 to about 1.2 bar to extract pectin from the pectin-containing plant material.

2. The process of claim 1, wherein the target temperature is from about 105° C. to about 115° C.

3. The process of claim 1, wherein the target temperature is from about 110° C. to about 115° C.

4. The process of claim 1, wherein the mixture is maintained at the target temperature for a time from up to about 4 minutes.

5. The process of claim 1, wherein the mixture is maintained at the target temperature for a time up to about 2 minutes.

6. The process of claim wherein the flash tank is at a pressure from about 0.8 to about 1.1 bar.

7. The process of claim 1, wherein the flash tank is at atmospheric pressure.

8. The process of claim 1, wherein the pectin-containing plant material comprises a fruit peel.

9. The process of claim 8, wherein the fruit peel is a citrus peel.

10. The process of claim 9, wherein the citrus peel is selected from the group consisting of an orange peel, lemon peel, lime peel, grapefruit peel, or combinations thereof.

11. The process of claim 1, wherein the ratio of the pectin-containing plant material to the acidic aqueous medium is from about 1:2 to about 1:40 (w/w).

12. The process of claim 1, wherein the ratio of the pectin-containing plant material to the acidic aqueous medium is about 1:3 (w/w).

13. The process of claim 1, wherein the acidic aqueous medium has a pH from about 1 to about 3.

14. The process of claim 1, wherein the acidic aqueous medium is a hydrochloric acid, nitric acid, acetic acid, oxalic acid, or a combination thereof.

15. The process of claim 1, further comprising cooling the mixture to about room temperature subsequent to flashing the mixture.

16. The process of claim 15, further comprising separating the extracted pectin from the mixture by filtration, adding an alcohol to the extracted pectin to precipitate the pectin, and separating the precipitated pectin.

17. The process of claim 16, wherein the alcohol is isopropyl alcohol or ethanol.

18. The process of claim 1, wherein the extracted pectin is characterized by an intrinsic viscosity from about 4.0 to about 8.0 as measured by size exclusion chromatography.

19. The process of claim 1, wherein the extracted pectin is characterized by an intrinsic viscosity from about 4.5 to about 6.5 as measured by size exclusion chromatography.

20. A pectin obtained by the process of claim 1.
